(19) United States
(12) Patent Application Publication
(10) Pub. No.: US 2010/0020229 A1
(43) Pub. Date: Jan. 28, 2010

(54) WEARABLE PERSONAL VIDEO/AUDIO DEVICE METHOD AND SYSTEM

(75) Inventors: John Erik Hershey, Ballston Lake, NY (US); Gary Mark Reiner, Westport, CT (US); Patia Jean McGrath, Fairfield, CT (US); Ignatius Boniface Dayan Anandappa, Ridgefield, CT (US); Parag Ramesh Goradia, Shelton, CT (US); Mark Lewis Grabb, Burnt Hills, NY (US); Mark Mastrianni, Westport, CT (US); Richard Anthony DeCristofaro, Niskayuna, NY (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 12/551,123

(22) Filed: Aug. 31, 2009

Related U.S. Application Data
(63) Continuation-in-part of application No. 11/796,907, filed on Apr. 30, 2007.

(51) Int. Cl. H04N 5/225

(52) U.S. Cl. 348/376; 340/10.5; 348/E05.024

(57) ABSTRACT

A system for capture and transmission of video and audio data includes multiple input devices, each designed to be worn by a user. The input devices capture video and audio signals corresponding to views available at the location of each user and transmit the information to a remote system. The remote system uses the video and audio signals to create enhanced views. These enhanced views may be transmitted to other input devices.

### CROSS REFERENCE TO RELATED APPLICATIONS

This application is a continuation-in-part of U.S. patent application Ser. No. 11/796,907, filed 30 Apr. 2007 entitled “WEARABLE PERSONAL VIDEO/AUDIO DEVICE METHOD AND SYSTEM” which is incorporated in its entirety herein by reference.

### TECHNICAL FIELD

The systems and techniques discussed herein relate generally to the field of video and audio communications devices, and more particularly to a device, method and system for capturing and transmitting unique personal user visual and audio inputs and sharing resulting visual and audio data with remote participants or devices.

### DISCUSSION OF RELATED ART

Many systems have been developed and are currently in use for capturing video and audio inputs and storing or transmitting video and audio data. For example, conventional cameras, webcams, and so forth can be interfaced with computer systems to transmit video and audio files, either stored or in real time, over networks, including the Internet. Similarly, portable devices are well known for sending video and audio messages wirelessly, most prominently various cellular telephone technologies, Bluetooth protocols, and so forth. Moreover, telephone and video conferencing technologies are quite mature, and now commonly utilize high speed networks such as the Internet.

However, there is a growing and unsatisfied need for a business and personal-suitable hands-free technique for capturing, processing and disseminating video signals and ancillary information corresponding to the unique view of a user. That is, rather than a view made by a static camera or hand-held camera, there is a need for more personalized views to be transmitted by a user in a way that will more immediately and accurately depict what the user sees and hears. Existing camera technologies, for example, do not typically permit hands-free operation, and generally are inappropriate for conferencing and transmission of personal views, particularly using conventional video conferencing technologies. Experimental systems, such as helmets or the like equipped with cameras are more a curiosity than a practical solution for most applications, particularly in business.

The present need is motivated by a standing requirement for a person to be able to record, process, disseminate, and have understood, his or her personal viewpoint. There is a further need to enable the reception and viewing of unprocessed or processed views made previously or in real time by others. There is also a continued desire for a system and components which can easily, unobtrusively, and comfortably integrate video and audio capture with the user, such as in a wearable device and provide improved information gathering and dissemination.

### BRIEF DESCRIPTION

In one aspect of a system in accordance with an embodiment described herein, a system for the capture and transmission of video and audio data is provided. A wearable input capture device is configured to be worn by a user and includes at least two video circuits and at least two audio circuits. Each video circuit is configured to capture a visual view available from the user's position, and each audio circuit is configured to capture an audio signal corresponding to sound as heard from the user's position. Power and control circuitry is provided for powering the audio and video circuits and also for controlling the transmission of the signals generated in the input capture device to a separate receiving device.

In another aspect of a system in accordance with an embodiment described herein, a system for the capture and transmission of video and audio data includes a plurality of input devices. Each input device is configured to be worn by a user and includes video and audio circuitry for capturing a video signal and an audio signal. The input device further includes a location identifying circuit for determining the position of the wearer of the device. The input device also includes transmission circuitry for controlling the transmission of the video signal, audio signal and position of the user. A remote system is provided that is configured to receive video and audio and position signals from the plurality of the input devices wirelessly. The remote system is configured to produce an enhanced video signal based on the combination of the video signals received and the position signals associated with each video signal.

### DRAWINGS

These and other features, aspects, and advantages of the systems and techniques disclosed will become better understood when the following detailed description is read with reference to the accompanying drawings in which like characters represent like parts throughout the drawings, wherein:

FIG. 1 is an elevational view of an earpiece and transceiver designed to be worn by a user for capture and transmission of video and audio signals in a CWIC system;

FIG. 2 is a diagrammatical overview of certain of the functional components which may be included in the elements shown in FIG. 1, along with components that cooperate to receive video and audio data and to transmit commands to the device, where appropriate;

FIG. 3 is a diagrammatical view of an exemplary earpiece designed for wireless operation;

FIG. 4 is a diagrammatical view of an exemplary earpiece permitting adjustment of the view captured during operation;

FIG. 5 is a diagrammatical view of another exemplary earpiece having a built-in interface for configuring the device, powering the device, charging the device, and so forth;

FIG. 6 is a diagrammatical representation of additional functional components which may be included in the wearable device of a CWIC system for providing additional information regarding location and orientation of the device, and for triggering certain operations; and

FIG. 7 is a diagrammatical overview of a CWIC system utilizing wearable devices in accordance with aspects of an embodiment of a system described herein.

### DETAILED DESCRIPTION

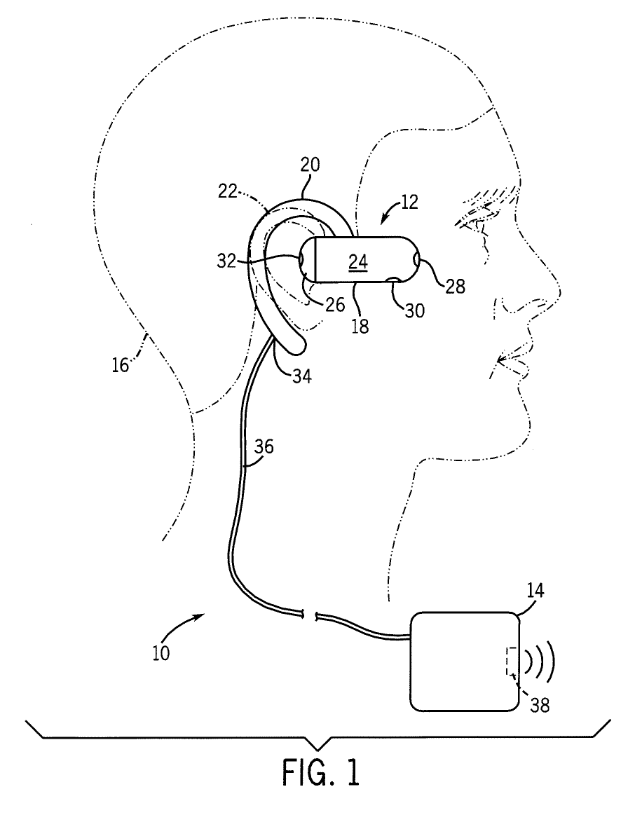

Turning now to the drawings, and referring first to FIG. 1, a “see-what-I-see” or “CWIC” video and audio capture system is illustrated generally and designated by the reference numeral 10. The capture system is designed to be worn by a user and to capture visible scenes and, where provided, audible sounds essentially similar to those experienced by the wearer. In the illustrated embodiment, the CWIC capture system includes an input capture device, or earpiece, 12 that works in cooperation with a power/transceiver unit 14. The earpiece (or other input capture device, as discussed below) is designed to be worn by the wearer 16, and itself includes a video/audio capture device 18 mounted on a support 20. The support 20 may be configured in various manners, and is preferably ergonomically formed to fit comfortably on the ear 22 of the wearer, or to be otherwise conveniently worn by a user without interfering with their ordinary behavior. The capture device 18, in the illustrated embodiment, includes a housing 24 in which sensors and associated circuitry are packaged, as described in greater detail below. The housing may have a rear cover 26 for accessing components within the housing and for packaging the components during manufacture. Although not illustrated, other support structures may also be envisaged, including light-weight bands that extend at least partially around the wearer's head to help hold the earpiece in place when in use, or placement on eyeglasses or eyeglass-like frames. In addition, placement of devices as described herein may be within, or attached to, cellphones, headsets for cellphones, headphones for use with personal audio devices, or within appropriate locations on clothing, such as collars of jackets. For outdoor applications, incorporation of such devices into support structures such as hats, helmets, or sunglasses is also contemplated.

Various sensors and subsystems may be included in the video/audio capture device 18. In a presently contemplated embodiment, the device will include one or more cameras for capturing video scenes, as well as one or more microphones for capturing sound. In the illustrated embodiment of FIG. 1, for example, a lens 28 is provided in a front position on the device to capture views seen by the wearer, typically in the visible spectrum. However, as will be appreciated by those skilled in the art, the optics and sensitivity of the device may permit the capture of scenes in near visible wavelengths, such as in the infrared spectrum. The microphone aperture 30 allows for audio data to be picked up by the device. A speaker 32 may also be provided in the housing or may extend from the housing, to allow the wearer to interface interactively with remote parties in real-time exchanges.

In the embodiment illustrated in FIG. 1, the capture device 18 is coupled to the power/transceiver unit 14 by means of a tether connection 34 to which a light-weight cable 36 is connected. The cable may be permanently secured to the tether connection, or may be separable from the connection, such as by means of a suitable connector (not shown). As described in greater detail below, the cable 36 allows for power to be transmitted from the power/transceiver unit 14 to the earpiece 12, and for the transmission of audio and video signals from the earpiece, and audio signals to the earpiece, particularly where a speaker is provided for the wearer. Moreover, in the view shown in FIG. 1, a transceiver 38 is provided in the power/transceiver unit 14 that permits wireless transmission of video and audio signals from the capture system, and for receiving audio signals for the wearer, where a speaker is provided. In one presently contemplated alternative arrangement, the earpiece may be retractably connected to, or pluggable into the unit 14. This arrangement offers the potential for recharging the earpiece by virtue of a connection to the unit 14.

In addition, it will be appreciated that a plurality of capture devices 18 might be connected to the same power/transceiver unit. Such embodiments will be discussed further below. The embodiment illustrated in FIG. 1 is presently contemplated to permit significant reduction in size and weight of the earpiece or other input capture device 12. As described in greater detail below, while current technologies motivate separation of power supplies, and certain processing functions to the power/transceiver unit 14, developing technologies may permit some or all of the circuits to be included in the earpiece, while still providing an ergonomic and comfortable device to wear. Such alternatives are described in greater detail below.

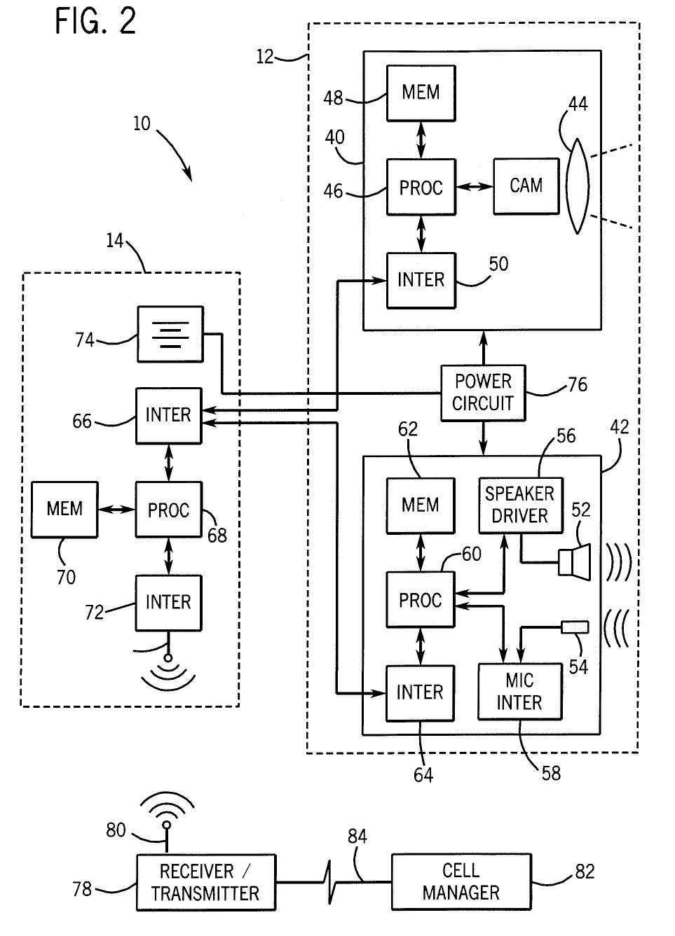

FIG. 2 is a diagrammatical overview of certain of the functional circuitry and subsystems that may be included in the CWIC capture system 10. As noted above with reference to FIG. 1, the system will, in a presently contemplated embodiment, include an earpiece 12 and a power/transceiver unit 14. The earpiece itself will typically include video circuitry, designated generally by reference numeral 40, and where audio signals are captured and provided, audio circuitry 42. The video circuitry itself will further include one or more cameras and associated optics, as designated generally by reference numeral 44. Any suitable video or camera device may be employed, such as CCD cameras, CMOS cameras, or similarly functioning technologies capable of forming video signals based upon received light. Signals from the camera are provided to a processor 46 which may include a filtering circuitry, sampling circuitry, analog-to-digital conversion circuitry, and so forth. In certain embodiments, it may be advantageous to reduce the functionality of the processing circuitry 46, so as to reduce power consumption in the earpiece. However, in general, some type of processing of the video signals will be performed in the earpiece for transmission to remote locations, including to unit 14. The processor 46 is generally served by support circuitry, particularly by memory 48 which stores programs or protocols implemented by the processing circuitry, as well as video data, where appropriate. The memory may also serve to store configuration settings for the processor, the camera, and other functional components. The video circuitry 40 will also typically include interface circuitry 50, such as communications circuitry for transmitting video signals from the video circuitry 40 to the power/transceiver unit 14.

The audio circuitry 42 similarly includes a number of functional components. In the illustrated embodiment, for example, a speaker 52 is provided as well as a microphone 54. The speaker is associated with a speaker driver circuitry 56 for powering the speaker and transforming received audio signals into appropriate signals to produce the audio output. Microphone interface circuitry 58 similarly receives signals from microphone 54, and may perform such functions as filtering, analog-to-digital conversion, encoding, decoding, encryption, compression and so forth. The speaker driver 56 and microphone interface 58 are coupled to a processor 60 which is programmed to carry out audio signal processing. Support circuitry may include memory circuitry 62 which serves to store routines executed by processor 60, and may store, at least temporarily, audio signals for transmission to the power/transceiver unit 14 through the intermediary of an interface 64.

The power/transceiver unit 14 similarly includes one or more interfaces 66 which communicate with interfaces 50 and 64 of the earpiece to receive video signals, and to send and receive audio signals. The interface circuitry 66 is coupled to processing circuitry 68 which coordinates the receipt and transmission of the video and audio signals, as well as their transmission to remote devices. The processing circuitry 68 may be served by a number of support circuits, such as memory circuitry 70 for storing the routines executed by the processing circuitry 68. Memory circuitry 70 may also store configuration parameters, data exchange protocols, and so forth needed for receipt and transmission of the video and audio signals, particularly their transmission to remote devices as described below. An interface circuit 72 is thus provided to permit wireless exchange of data between the power/transceiver unit 14 and remote devices.

It should be appreciated that, as mentioned above, multiple input capture devices 12, such as the above-described earpieces, may be used with a single power/transceiver unit 14 in a single overall system. Such multiple earpieces may be used to provide additional input streams that may be passed to the interface circuitry 66 of the power/transceiver unit in order to improve or augment the data collected by the system 10. Such additional input capture devices need not be limited to an earpiece exactly as shown in FIG. 1, but may include any additional source of appropriate input, whether mounted on a device conformable for wearing on a user's ear or not. Through the discussion herein, the term “earpiece” should be understood to mean any input capture device 12, i.e., any data-gathering portion of the system that collects information and passes it to the interface circuitry of the power/transceiver unit, regardless of form.

Such variations may include input capture devices that only provide audio input streams, devices that provide only video streams, devices that provide location or orientation information (such as accelerometers, inclinometers or GPS locators), and devices that provide more than one of the above. For instance, in an device that is mounted on an eyeglass-like frame, two video streams (e.g., one corresponding approximately to each eye), two audio streams (e.g., one corresponding to each ear), and an inclinometer input (to indicate whether the wearer is facing upwards or downwards) may all be provided from a single “earpiece” to the transceiver unit.

In other variations, the same inputs may be provided by a pair of separate devices, one worn on each ear, and each independently providing input to the interface circuitry 66 of the power/transceiver unit 14. It will be appreciated that a variety of these variations may be made as desired to fit the appropriate input streams for use in the ultimate end use. More details of various end use and remote processing will be described below.

It should also be noted that other circuitry that may be included in the earpiece, the power/transceiver unit 14, or both may include circuitry for buffering, storing and forwarding audio and video signals based on the availability of the underlying network or connection. Similar circuitry may be included in the circuitry to which the signals are sent, as discussed in greater detail below. Similarly, the earpiece or the power/transceiver unit, or both, may include indicia to notify users and persons whose images or voices may be captured by the system that the system is currently recording. Such indicia may include, for example, light emitting diodes, blinking lights, and so forth. Still further, the earpiece or the power/transceiver unit, or both may include an indicator, and where desired, a selector, for indicating and selecting among a plurality of signal transport technologies (e.g., 2G, 3G, Wifi, WiMax, and so forth).

For example, the system may automatically select a “best” transport mechanism or protocol, such as based upon a signal or connection strength, or may enable a user to select such technologies. Other variations may include a system that transmits information to the nearest valid network node that is capable of passing the information on to the ultimate destination. Such a “mutter mode” technique may be effective for conserving power, and will be discussed further below with regard to use of multiple systems forming a network of related devices within a single area.

Still further, the circuitry of the earpiece and/or the power/transceiver unit may include one or more sensors for detecting environmental conditions or conditions of the wearer or even of persons or equipment in the environs of the user. By way of example, such sensors may include temperature sensors, chemical sensors, sensors for detecting vital signs, and so forth. In exemplary implementations, for example, a fire fighter or service technician may need to detect temperatures or air qualities. A physician may need to detect vital signs of a patient. The circuitry of the system, then, may collect sensed signals from such sensors, encode the information in an appropriate protocol and transmit the encoded information along with audio and/or video signals collected via the system. Such signals may also include the orientation/location signals discussed above, which may provide further useful telemetry information for various applications.

In the presently contemplated embodiment illustrated in FIG. 2, a power source 74, such as one or more batteries, is included in the power/transceiver unit 14, and is coupled to power circuitry 76 in the earpiece. Relatively low levels of power will be typically demanded by the circuitry of the earpiece, and these may be distributed by the power circuitry 76, which may also perform voltage regulation functions, and so forth.

The interface circuitry 72 of the power/transceiver unit 14 is equipped to communicate wirelessly with one or more receiver/transmitter units 78. Unit 78 may, in some embodiments, include a general purpose or application-specific computer coupled to a wireless interface, as designated generally by reference numeral 80 for exchanging data in accordance with any one or many known wireless protocols. Wireless protocols may include, for example, protocols known by the designations Bluetooth, ZIGBE, IEEE 802.11. Other presently contemplated wireless transmission technologies may include infrared connections, radio frequency connections, cellular telephony protocols, and so forth. In presently contemplated embodiments, the receiver/transmitter unit 78 will be local to the user. However, in future embodiments, particularly where longer range wireless communication is possible directly from the CWIC capture system 10, significant distances may exist between the capture system and the receiver/transmitter unit. Indeed, cellular protocols may be implemented directly in the CWIC capture system 10, with video and audio signals being transmitted directly via a cellular or similar network. In the illustrated embodiment, the receiver/transmitter unit 78 is coupled to a cell manager or similar controller, designated by reference numeral 82, via a network connection 84. The cell manager may carry out such functions as identifying permitted users or controlling access to the video and audio input from the capture system, controlling access by the capture system to a data transmission network, and so forth, as described in greater detail below with reference to FIG. 7.

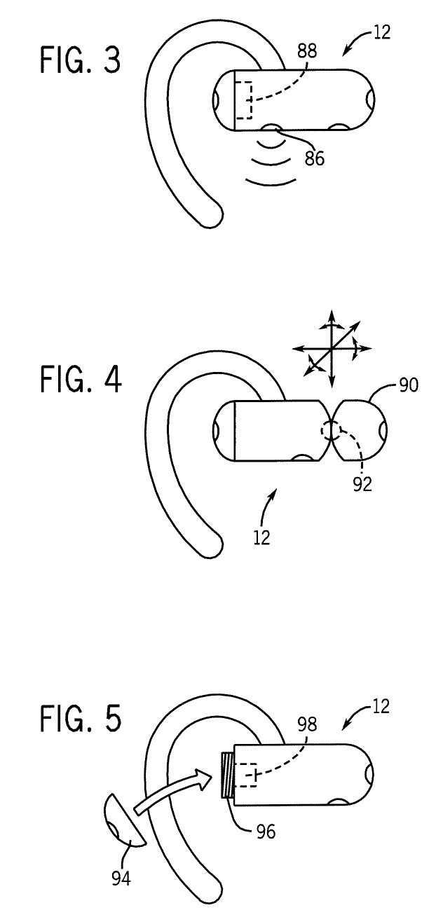

A number of variations may be envisaged for the capture system, and particularly for the earpiece 12. Certain of these are illustrated in FIGS. 3, 4, and 5. In the alternative implementation of FIG. 3, a completely wireless earpiece 12 is provided. Functional components of the wireless earpiece may be essentially similar to those described above. However, the wireless earpiece is provided with a wireless transceiver 86 that allows it to communicate data in accordance with a wireless protocol such as one of the protocols or techniques mentioned above. To permit the earpiece to function wirelessly, that is, free from wire connections to a power/transceiver unit or any similar device, an on-board battery 88 may be provided. Such a local connection may be used directly to allow the earpiece to communicate exclusively with its associated power/transceiver unit 14, or may be configured to allow the device to communicate directly with any other power/transceiver unit within range.

In the alternative configuration of FIG. 4, an orientable camera 90 positioned on a front end of the earpiece and coupled to the earpiece via a multi-axis joint 92. In the simplest implementation, the joint 92 may permit one degree of freedom in the movement of the camera 90, although other degrees of freedom of movement may be provided. The implementation of FIG. 4 allows for the camera 90 to be oriented in a direction that most closely matches the view of the wearer.

In alternate embodiments, such a camera may be able to be configured to provide a video capture of what would be considered “peripheral vision”, by mounting the camera (or allowing it to be re-oriented) to provide imagery that is off to one side of what the wearer is directly viewing. By appropriate orientation of such a camera, or through the use of additional cameras on a single earpiece, views to the side, rear, or even above and below the field of view of the wearer may be captured and passed along as desired to the power/transceiver unit 14.

The alternative configuration of FIG. 5 includes a removable rear cap 94 which may be selectively removed from the housing of the earpiece, such as via snap engagement, threads 96, or otherwise to expose a plug-in interface, receptacle or jack 98. The jack may allow for interfacing with a conventional cable, such as a USB, mini-USB, compact flash, SD, mini-SD, or other communications cable. Such cables may be used to access programming within the device, reprogram the device, set parameters, such as for video and audio sampling, spatial resolution, and so forth. Of course, these and other innovations may all be incorporated into the earpiece, where desired.

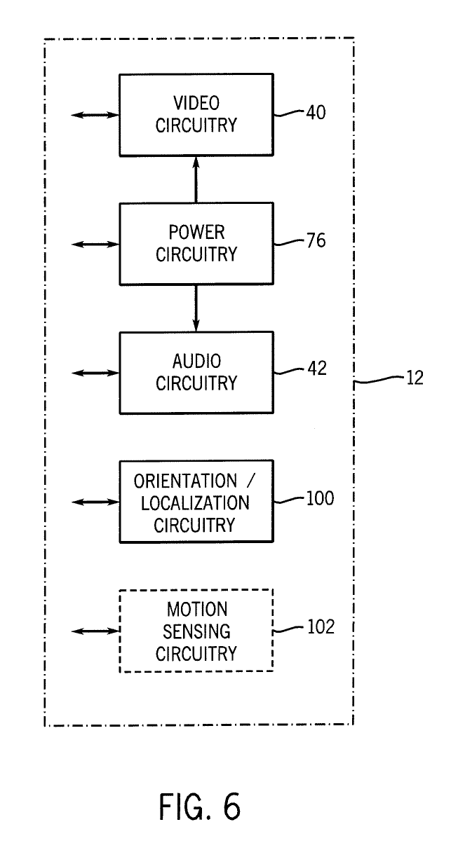

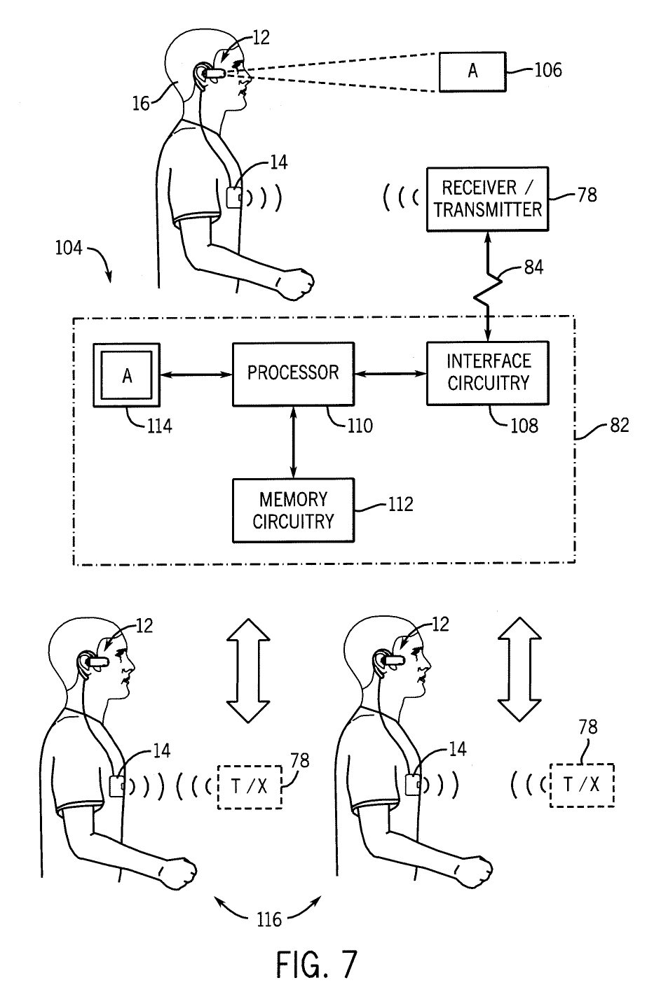

FIG. 6 illustrates selected exemplary additional functional circuitry that may be included in the earpiece to provide enhanced functionality as described below. The earpiece, in this implementation, may include video circuitry 40 and audio circuitry 42, as described above, along with power circuitry 76. Moreover, in the implementation of FIG. 6, orientation/localization circuitry 100 may be provided. Such circuitry may include, for example, electronic compass inputs, global positioning system circuitry, RF sensors, and so forth capable of determining the location or relative location of the earpiece or of the wearer, and in certain implementations, the orientation of the wearer. This information may be used, for example, to adjust views displayed by a remote viewer as described below.

Furthermore, other devices such as RFID readers may be included to provide context information related to the location of the wearer. For instance, when working on field equipment, various items within the equipment may have RFID tags that, when brought within range of the CWIC device, may provide information that communicate status via relay back to the remote devices, as well as providing information directly to the wearer of the device. In addition, in locations where RFID tags are used to mark particular locations within a space (such as a conference center, warehouse, or retail outlet), such information can be used to provide location, as well as functional context (e.g., if RFID tags are used to indicate which section of a retail outlet you are in).

Moreover, the earpiece may include motion sensing circuitry, designated generally by reference numeral 102. Such circuitry may include, for example, one or more accelerometers capable of determining when the earpiece is being moved, or worn, or when the wearer has changed positions such that a new view is available. As described below, for example, video and audio capture may be initiated or suspended based upon detected movement of the earpiece, so as to reduce power consumption and improve efficiency of bandwidth and memory utilization.

The foregoing arrangements are designed to function in a system which, in the present context, is termed the CWIC system. The CWIC system may be designed to provide for controlled access to networked or conference components in much the same way that conferencing models are presently used. That is, the wearer or user of the CWIC capture system may be required to maintain an up-to-date subscription for transmission of video and audio signals via the CWIC system. Other models may be based upon a pay-per-use arrangement with the user. In certain implementations, therefore, the user may be required to access the CWIC system by appropriate input of access code, such as via the receiver/transmitter unit 78 described above. This information may include, for example, user identification and password authentication, encryption protocols, session identifications, and so forth. The CWIC system itself may include a number of interface components as generally represented in FIG. 7. Where desired, encryption and transition between encrypted and non-encrypted audio and video content over wired or wireless connections to the remote systems may be provided where data may be decrypted and displayed or played based upon individual user characteristics (such as subscriptions, security levels, permissions, and so forth).

Such displays may also include displays that provide enhanced detection of information that, while present in the visual or audio stream of a user, are normally undetectable by ordinary human senses. For instance, the system may include the ability to detect light wavelengths outside of normal human vision, such as near-infrared, and then to display an indication of those wavelengths overlaid on the actual visual scene. Such a feature (similar to the “night shot” mode on camcorders) could be used at a variety of wavelengths to provide for enhanced detection capabilities that might be of especial use for technicians.

Another feature that can be provided in cooperation with back-end processing is an “identify” mode. In such an embodiment, a user of a CWIC device can trigger an ‘identify’ request for a particular item within the audio-visual field of experience of the user. Such request may be triggered by voice command, button push, or any other technique deemed appropriate. When made, the appropriate input is tagged and forwarded on to the central CWIC system for comparison or searching in order to identify the input. This result may then be displayed back to the user, or transmitted for audio playback to the wearer.

For instance, in a visual identity mode, a wearer could look at a speaker and trigger an ‘identify’ request. The image of the speaker would be forwarded from the CWIC device to the CWIC system for analysis. Once identified, the speaker's information could be displayed back to the CWIC device wearer, if an appropriate display were available, or the speaker's information could be presented via audio to the CWIC device wearer.

Such systems may be further enhanced by allowing for requests for identification to be forwarded to other CWIC device users on the same network, allowing for others in the area to provide information that might be more readily known than to the remote CWIC system. Such a system combines a social-networking effect with the CWIC device to provide for rapid information dissemination within a networked group of CWIC users.

Such identification systems can also provide information for more formal identification systems, such as bar codes, serial numbers, RFID tags, or other coded systems. For instance, if a field technician is working with a piece of equipment, and looks at an unknown part whose serial number is available, an “identify” request can be used to provide the appropriate information about the particular part of equipment. Such requests can also be configured to happen automatically when RFID tags or bar codes are identified within the CWIC device environment.

In addition to such modes that provide for controlled access similar to a standard conferencing model, such a CWIC system may also be configured to be a data source for a more open, collaborative network of such devices, where each device is capable of passing information along for relay to the other CWIC devices on the network. When combined with appropriate processing, this may allow for a variety of advanced features, as discussed below.

One feature of a CWIC system that may be provided by certain embodiments is to more fully capture the user experience by including multiple audio or video inputs on a single input capture device 12, or by providing input from multiple input capture devices to a single user's power/transceiver unit 14. For instance, by placing two video inputs, one near the wearer's right eye and the other near the wearer's left, stereo imagery similar to what is actually perceived by the user can be captured and transmitted to the power/transceiver unit. Such multiple input may be used to estimate distance to various objects within the field of view, and to perform such other operations as are known to be possible with such a stereoscopic video capture.

In addition, the use of a plurality of video inputs may also be used to capture imagery associated with a user's peripheral vision, or even to capture video for areas that are not within the user's visual field at all (for example, directly to the rear of the wearer). Such super-normal visual capture may be used in a variety of ways, both on-board, and remotely. For instance, if a CWIC system were equipped with a rearward facing camera in addition to a forward facing camera, it might prove very effective for field technicians working on equipment while in communication with a central office. Such information could provide important situational awareness for the remote personnel that would otherwise be unavailable. In addition, such a system could provide important information for users participating in events, such as sporting events (e.g., racing), in which a rearward view is desirable. Such a view could also be provided back to the user via a display (whether integral with the CWIC system or not) to provide such enhanced vision to the wearer himself.

In addition to the use of a plurality of video inputs, multiple audio inputs can also be used for a variety of purposes. In the simplest case, a pair of audio inputs, one for each ear, can be used to provide stereo sound for transmission to remote receivers on the network. However, such stereo audio input can also be used to enable features such as direction-finding for particular sounds. Multiple audio inputs can also be used to enable noise-cancelation. For instance, by comparing the audio streams received by two separate microphones, it may be better able to distinguish between background noise and the desired audio signal. Techniques for such audio processing are known in the art, and can be applied as generally understood to the multiple audio streams provided.

In general, such techniques can be used to provide for higher resolution video and audio than would be possible by a single camera or microphone working alone. Such fusion of multiple streams to improve audio and video can be performed using a variety of techniques appreciated in the art. The provision of multiple source streams is generally necessary for such techniques to be applied and they will therefore be unavailable without the capture of multiple streams. These streams may be provided by multiple input capture devices 12 on a single CWIC device, or may be fused from time- or position-correlated streams from separate CWIC devices that are observing the same environment.

In the embodiment illustrated in FIG. 7, the CWIC system 104 makes use of one or more CWIC capture systems 10 worn by one or more users 16. The capture system, then, generates video and audio signals which may be considered to represent a scene 106, designated by the letter “A” in FIG. 7. Any suitable update or sampling rate may be used to provide the desired level of video or audio quality. Presently contemplated embodiments, for example, may employ a video sampling rate of 30 frames/second, although lower rates may be used. Various spatial resolutions may be employed for the video as well, such as 320×320 lines, employing cameras of from 500 kpixel to 2 Mpixel cameras, although other spatial resolutions may be afforded. Moreover, various wireless bandwidths may be used, with presently contemplated bandwidths being 200 kbit/second. Bluetooth wireless communications, for example, may provide at present up to 1 Mbit/second transmission.

In the embodiment illustrated in FIG. 7, the video and audio signals are received by the receiver/transmitter 78 and are then transmitted to the cell manager 82 via the network connection 84. The cell manager itself may include interface circuitry 108 configured to receive and decode the video and audio transmissions. Processing circuitry 110 allows for processing of the signals, and, where desired, reformatting the signals for display or retransmission. The processing circuitry 110 will be served by support circuitry, such as memory circuitry 112 which stores routines executed by the processor, and which may also store, temporarily or on longer term bases, audio and video signals, such as in a form of transmission files for specific sessions. Other memory circuitry may be provided beyond the cell manager 82 itself for this purpose. Indeed, entire libraries or repositories of video and audio files may be provided in the system. In general, the cell manager may also include one or more display or interface devices 114 which reproduce the scenes and audio received from the wearer 16.

The CWIC system 104 may provide for individual receipt, storing, or communication of video and audio signals from single users or wearers. However, it should be noted that the system may interface with any number of wearers or users of capture systems 10, as indicated by reference numeral 116 in FIG. 7. More generally, the model for the overall system may allow for conferencing services to be provided, such as on a subscription or pay-per-use basis, with multiple video providers providing video and/or audio to the system, and multiple viewers logging into the system and accessing specific video and/or audio on appropriate paid license or free bases. The processing circuitry 110, in such instances, may include more elaborate back office functionality to prompt payment or verification of access rights, verification of passwords, and so forth before video providers can post content, or before viewers can view content.

Such multiple CWIC devices may also be combined into a network of users. Such a network may be the set of all users that are communicating with the same CWIC system 104. The network may also include CWIC devices that are capable of communicating directly with one another. Such a direct network may provide for additional benefits. For example, when CWIC devices can communicate directly to one another, it may be possible for one CWIC device that does not have an effective chancel for communication directly to the CWIC system 104 through the receiver/transmitter 78, to pass its processed data along to another CWIC device that does have a better connection to the receiver/transmitter of the CWIC system.

Such a feature can be especially useful when operating indoors where certain locations within a conference hall may have physical barriers that block signal transmission in certain directions or may be subject to interference that prevents effective signal strength from reaching the appropriate receiver. In such instances, passing a signal to a separate nearby CWIC that is not subject to the same interference or blockage may allow the user's signal to be sent despite the poor direct connection environment.

In addition, by having multiple CWIC devices communicate directly with one another, it is possible for the devices within such a network to determine which of them provides the best signal path for communication and which can therefore communicate most efficiently in terms of power usage. Such a technique can be used to conserve the overall power usage of the CWIC devices within the network by having those devices with the most efficient communication path perform the uplinking of information for devices who are unable to communicate directly without increasing power usage, or for devices who are low on battery power to have the more power-intensive long-range communications handled by devices with more energy in reserve. Such a technique is disclosed more fully in U.S. Pat. No. 5,588,005 entitled “PROTOCOL AND MECHANISM FOR PRIMARY AND MUTTER MODE COMMUNICATION FOR ASSET TRACKING”, issued 24 Dec. 1996, and incorporated herein in its entirety.

Such networks of CWIC devices may also provide for additional benefits when data from multiple CWIC devices are combined at the CWIC system processor 110. For instance, in a conference in which multiple CWIC devices are in use and communicating to the same CWIC system 104, the separate video views may be combined to provide an overall mosaic view of a scene, and providing more effective position information than would be possible otherwise. This can be especially effective when location and pointing information is also available for the individual CWIC devices. Such triangulation of particular features within the scene can be used to provide a three-dimensional map of the objects within the visual field of multiple CWIC devices. Such a ‘mob view’ can be provided back to CWIC device wearers if desired, or may simply be used to create a more complete, composite view that takes into account the input from multiple users.

In addition, multiple CWIC devices that provide separate, but simultaneous, data streams may also be treated similarly to multiple inputs passed to the same power/transceiver unit and used to create stereo visual or audio fields that enable depth perception or direction finding.

When a display is also provided, as mentioned above, the ability of the central CWIC system to determine the three-dimensional placement of objects within a user's field of view can also be used to provide a virtual image that may enhance the actual view available. For instance, in a press conference with multiple attendees having CWIC devices on the same network, it may be possible to provide imagery to a user that include the significant parts of the field of view, even if those portions of the field of view are not actually visible to that particular user directly, by using the information provided by the other CWIC devices on the network. In such a way, a reporter who was situated at the edge of a room, or whose field of view were otherwise occluded, could be provided with what they would see were it not for the obstruction. In this way, a user who wanted to watch a presenter, for example, could pass through the room and never lose sight of the presenter and presentation, even as columns, other people, and equipment temporarily blocked the user's view of the subject.

Networked CWIC devices may also be used to provide data throughput and bandwidth advantages. For instance, while a single cellular modem may have limitations on the effective data rate that can be used to send video, by using multiple users, each of whom has a CWIC device viewing the same scene from similar vantage points, a very high quality view may be provided by combining the individual views. In such a way, high-definition video may be made available despite the lack of a single data path capable of supporting sufficient bandwidth for a high-definition video stream.

Application of the CWIC system and devices described herein a variety of fields. For instance in news and traffic reporting, dedicated reporters (or individuals acting as part of an ad-hoc network and providing input from their personal CWIC device as they drive) can be used to enhance the information provided to producers and for broadcast. In sports, applications may include general telemetry data, for instance for races as mentioned above, as well as for referees who wish to consult with other officials regarding the consequence of what they actually viewed while on the field. Such devices may also be used for collection of player telemetry, even if only worn on the sidelines, to provide for a more complete model of a game as it is played.

Such devices may also find use in advertising, especially for live events, where users who are inside the venue, such as a concert or theme ride, may have their view provided to those outside the ride to give a taste of what the experience to be had is like, for instance on a marquis outside a concert or play. If there are seats still available, providing periodic clips of video/audio from the actual performance in real time may encourage passers by to consider a ticket purchase.

In presently contemplated embodiments, to provide greater facility to the user in interfacing with the CWIC system, visible and/or audible indicators may be provided to inform the user that video and/or audio data is being acquired or is streaming through the system. Such indicators may include, for example, non-intrusive beeps, periodic beeps, or other audio clues. Similarly, visual indicators, such as colored LEDs, blinking LEDs and so forth may be provided for the same purpose. The system may also respond to audio commands, where desired, allowing the user complete hands-free control. For example, the user may speak commands such as “start streaming video” to control operation of the capture system. Similarly, particular audio or visual feedback may be provided to inform the user of the quality or bandwidth or resolution of the video and/or audio signals, the cost associated with transmission, and so forth.

Where desired, the earpiece, the power/transceiver unit, or the remote components with which these cooperate may include delay circuitry that adds a desired delay before transmission of the audio and video signals to a connected user or receiver of the content. Such delays may allow for the user of the system or for controllers at the CWIC system level to prevent transmission of audio signals, video signals, or both, should the system inadvertently capture inappropriate content.

Exemplary uses of the system described above may be many. As noted above, the system may be used, for example, for replacement of conventional video conferencing. Moreover, the system may be used to allow for expert direction of less trained personnel, such as for servicing, part replacement, troubleshooting of complex systems and equipment, and so forth. More generally, the system may be used for any application where video and audio input is desired, and where a view conforming much more closely to that experienced by the user is desired, as compared to existing video capture and transmission systems. Thus, the system may also provide collaboration and sharing of public and/or private (secure) content along with a medium that will enable users of the system to interact with the producers of the content along with the content itself.

While the systems and techniques herein have been described with reference to exemplary embodiments, it will be understood by those skilled in the art that various changes may be made and equivalents may be substituted for elements thereof without departing from their essential scope. In addition, many modifications may be made to adapt a particular situation or material to the teachings of a given embodiment without departing from the essential scope thereof. Therefore, it is intended that these systems and techniques are not limited to the particular embodiments disclosed as the best mode contemplated for carrying them out.

The various embodiments described herein may be examples of wearable personal audio/video devices using such components and techniques as described herein. Any given embodiment may provide one or more of the advantages recited, but need not provide all objects or advantages recited for any other embodiment. Those skilled in the art will recognize that the systems and techniques described herein may be embodied or carried out in a manner that achieves or optimizes one advantage or group of advantages as taught herein without necessarily achieving other objects or advantages as may be taught or suggested herein.

1. A system for the capture and transmission of video and audio data comprising:
a wearable input capture device configured to be worn by a user, the wearable input capture device including a plurality of video circuits configured to capture at least two visual signals corresponding to views available from the user's position, and a plurality of audio circuits for capturing at least two audio signals corresponding to sound heard from the user's position; and
power and control circuitry for powering the video and audio circuitry and for controlling transmission of the video and audio signals from the input capture device to a separate receiving device.

2. The system of claim 1, wherein the power and control circuitry is integrated into the wearable input capture device.

3. The system of claim 3, wherein the wearable input capture device is configured for wireless communication to at least one remote device.

4. The system of claim 1, wherein the wearable input capture device comprises a first earpiece and a second earpiece, each configured to be worn on a user's ear, and each of the first earpiece and second earpiece provides at least one of the visual signals and at least one of the audio signals to the power and control circuitry.

5. The system of claim 1, wherein the power and control circuitry is configured to generate a depth model of the visual field based on the multiple visual signals, the depth model including information regarding the distance of objects in within the visual signal from the user.

6. The system of claim 1, wherein the receiving device is configured to receive visual and audio signals from a plurality of wearable user input devices.

7. The system of claim 6 wherein the receiving device includes a processor for generating a synthetic view of an object within the visual signal received from a plurality of wearable input capture devices.

8. The system of claim 7 wherein the receiving device transmits the synthetic view of the object to a display associated with one of the plurality of wearable input capture devices that has an occluded view of the object in order to provide a view of the object from the point of view of the wearer of that wearable input capture device having the occluded view.

9. The system of claim 7 wherein the synthetic view is provided as a display to viewers remote from the object for advertising purposes.

10. The system of claim 7 wherein the synthetic view is provided as a display for use in a sporting event.

11. The system of claim 1 further incorporating an RFID reader.

12. The system of claim 11 wherein the wearable input device is configured to receive RFID information from an RFID tag in the environment of the wearable input device and further configured to transmit the RFID information to the receiving device, and the receiving device is configured to identify an object associated with the RFID information and transmit this information back to the wearable input device.

13. The system of claim 12 wherein the receiving device includes a processor for generating a synthetic view of an object associated with the RFID tag and is further configured to transmit the synthetic view of the object to the wearable input capture device.

14. The system of claim 1 further wherein the wearable input capture device incorporates a location-determining device, and is configured to transmit the location information to the receiving device.

15. The system of claim 14 wherein the receiving device generates a location of an object within at least one of the plurality of video signals based upon the video signal and the location information.

16. A system for the capture and transmission of video and audio data comprising:
a first input device configured to be worn by a first user, the first input device including video and audio circuitry for capturing a first video signal and a first audio signal corresponding to views available from the location of the first user, and a first location identifying circuit for identifying the position of the first user, and further including a first transmission circuitry for controlling transmission of the first video signal, first audio signal, and the position of the first user from the first input device;
a second input device configured to be worn by a second user, the second input device including video and audio circuitry for capturing a second video signal and a second audio signal corresponding to views available from the location of the second user, and a second location identifying circuit for identifying the position of the second user, and further including a second transmission circuitry for controlling transmission of the second video signal, second audio signal, and the position of the second user from the second input device; and
a remote system configured to receive the first and second video signals and first and second audio signals and positions of the first and second users wirelessly and to produce an enhanced video signal based on the combination of the first video signal, the second video signal, and the position of the first and second user.

17. The system of claim 16 wherein the remote system is further configured to produce an enhanced audio signal based on the combination of the first audio signal, the second audio signal and the position of the first and second user.

18. The system of claim 16 wherein the remote system is configured to transmit the enhanced video signal back to one of the first input device and the second input device.

19. The system of claim 17, wherein access to the remote system is regulated based upon a subscription or a pay-per-use license arrangement.

20. The system of claim 17, wherein the first transmission circuitry is further configured to communicate with the second transmission circuitry.
